(19) United States
(12) Patent Application Publication
(10) Pub. No.: US 2026/0147487 A1
(43) Pub. Date: May 28, 2026

(54) CORRUPT BLOCK DETECTION FOR WRITE ORDERING

(71) Applicant: Micron Technology, Inc., Boise, ID (US)

(72) Inventors: Naveen Bolisetty, Suryapet (IN); Sudhakara Rao Murala, Hyderabad (IN); Sai Kiran Vaikuntam, Hyderabad (IN)

(21) Appl. No.: 19/393,470

(22) Filed: Nov. 18, 2025

Related U.S. Application Data
(60) Provisional application No. 63/725,371, filed on Nov. 26, 2024.

(51) Int. Cl. G06F 3/06

(52) U.S. Cl. CPC G06F 3/0619; G06F 3/0659; G06F 3/0679

(57) ABSTRACT

Methods, systems, and devices for corrupt block detection for write ordering are described. A memory system may be configured to implement a sequential programming order or a reverse programming order based on dynamically reconfiguring memory dies to support storing data or parity data. For example, a memory system may receive a write command for writing data and parity data to a block stripe spanning the memory dies of the memory system. The memory system may determine whether the block stripe includes a corrupted block at a parity die of the memory system. The memory system may perform a write operation corresponding to the write command using the sequential programming order based on determining the block stripe does not include the corrupted block at the parity die, or the reverse programming order based on determining the block stripe includes the corrupted block at the parity die.

### CROSS REFERENCE

The present Application for Patent claims priority to U.S. Patent Application No. 63/725,371 by Bolisetty et al., entitled “CORRUPT BLOCK DETECTION FOR WRITE ORDERING,” filed November 26, 2024, which is assigned to the assignee hereof, and which is expressly incorporated by reference in its entirety herein.

### TECHNICAL FIELD

The following relates to one or more systems for memory, including corrupt block detection for write ordering.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports corrupt block detection for write ordering in accordance with examples as disclosed herein.

FIG. 2 shows an example of a block programming diagram that supports corrupt block detection for write ordering in accordance with examples as disclosed herein.

FIG. 3 shows an example of a process flow that supports corrupt block detection for write ordering in accordance with examples as disclosed herein.

FIG. 4 shows a block diagram of a memory system that supports corrupt block detection for write ordering in accordance with examples as disclosed herein.

FIG. 5 shows a flowchart illustrating a method or methods that support corrupt block detection for write ordering in accordance with examples as disclosed herein.

### DETAILED DESCRIPTION

A memory system (e.g., a NAND system) may include a quantity of memory dies (e.g., NAND dies), each including multiple planes where each plane is associated with a quantity of blocks (e.g., blocks of NAND memory cells). In some cases, a set of blocks including one block from each plane of each memory die may be referred to as a block stripe (e.g., each block of the block stripe may be associated with a same block index value within the respective plane that includes the block). In some cases, the memory system may be configured to write data and parity data corresponding to the data to each block stripe of the memory system (e.g., sequentially). For a given block stripe, the blocks associated with a specified memory die (e.g., a parity die) may be configured as a default storage location for the parity data associated with the data written to other blocks of the block stripe (e.g., associated with other memory dies aside from the parity die). For example, the data may be written in a sequential order across the other blocks (e.g., associated with the other memory dies) of the block stripe, and the parity data may be written to the block stripe at the blocks associated with the parity die. However, in some examples, a block associated with the parity die (e.g., within the block stripe) may become corrupted, and the parity data may be written to other blocks associated with another memory die (e.g., within the block stripe). In some such examples, the blocks (e.g., of the block stripe) that are associated with the parity die may be retired (e.g., based on one or more blocks being corrupted), which may decrease efficiency and capacity for storing information within the memory system.

In accordance with examples as described herein, a memory system may be configured to implement a reverse programming order for writing parity data to a block stripe with one or more corrupted blocks at the parity die. For example, the memory system may be configured to write data and corresponding parity data according to a sequential programming order based on determining that the blocks of the parity die (e.g., within the block stripe) are not corrupted. In some such examples, the memory system may write the data and the parity data to the blocks of the block stripe across the memory dies such that the parity data is stored at the blocks of the parity die. However, in other examples, the memory system may be configured to write the data and the parity data according to a reverse programming order based on determining that one or more blocks of the parity die (e.g., within the block stripe) are corrupted. In some such examples, the memory system may write the data and the parity data to the blocks of the block stripe across the memory dies such that the data is stored at the non-corrupted blocks of the parity die and the parity data is stored at the blocks of an initial (e.g., or selected) memory die otherwise associated with storing data according to the sequential programming order. That is, if the parity die includes a single corrupted block, the data may be written to other blocks associated with the parity die (e.g., within the block stripe) using the reverse programming order. Implementing the reverse programming order may therefore prevent the memory system from retiring all the blocks of the parity die based on determining a single block is corrupted, which may improve efficiency and capacity for storing information within the memory system (e.g., compared to previous implementations), among other advantages.

In addition to other benefits as described herein, techniques for corrupt block detection for write ordering may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by enabling a memory system to be configured with a sequential programming order or a reverse programming order based on corrupt block determination, which may improve efficiency for storing data at the memory system, among other benefits.

Further, the amount of waste (e.g., electronic waste) associated with disposal of electronic devices may also pose environmental concerns. Implementing the techniques described herein may improve the impact related to electronic devices by enabling a memory system to be configured with a reverse programming order based on corrupt block determination, which may improve a capacity for storing data at the memory system, resulting in extending the life of electronic devices and thereby reducing electronic waste, among other benefits.

Features of the disclosure are illustrated and described in the context of systems, devices, and circuits. Features of the disclosure are further illustrated and described in the context of a block programming diagram, a process flow, and a flowchart.

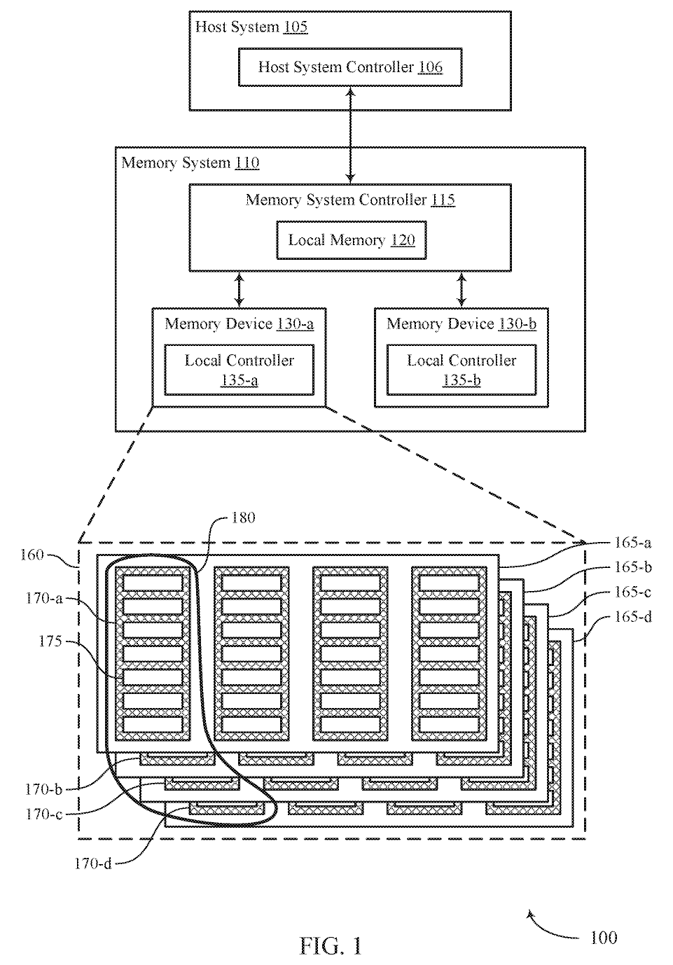

FIG. 1 shows an example of a system 100 that supports corrupt block detection for write ordering in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b. A local controller 135 may be or include a microcontroller, special purpose logic circuitry (e.g., a field programmable gate array (FPGA), an application specific integrated circuit (ASIC), a digital signal processor (DSP)), or any other suitable processor or processing circuitry.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block 180 may include blocks 170 from different memory devices 130 (e.g., including blocks in one or more planes of memory device 130-a and memory device 130-b). In some cases, the blocks 170 within a virtual block 180 may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165). In some cases, a block stripe may include multiple virtual blocks 180 (e.g., across multiple memory dies 160, the virtual blocks 180 corresponding the same block address within their respective planes of their respective dies may collectively be a block stripe).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete and may update a logical-to-physical (L2P) mapping table to associate the logical address (e.g., LBA) for the data with the new, valid block 170 rather than the old, invalid block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by the local controller 135 or memory system controller 115.

The memory system 110 may include a quantity of memory dies (e.g., memory devices 130), each including multiple planes 165 where each plane 165 is associated with a quantity of blocks 170. In some cases, a set of blocks 170 including one block 170 from each plane 165 of each memory die may be referred to as a block stripe. In some cases, the memory system 110 may be configured to write data and corresponding parity data to each block stripe of the memory system 110. For a given block stripe, the blocks 170 associated with a parity die (e.g., a memory die configured for storing parity data) may be configured as a default storage location for the parity data. For example, the data may be written in a sequential order across other blocks 170 (e.g., associated with the other memory dies) of the block stripe, and the parity data may be written to the block stripe at the blocks 170 associated with the parity die. However, in some examples, a block 170 associated with the parity die (e.g., within the block stripe) may become corrupted.

In accordance with examples as described herein, the memory system 110 may be configured to implement a reverse programming order for writing parity data to a block stripe with one or more corrupted blocks 170 at the parity die. For example, the memory system 110 may be configured to write data and corresponding parity data according to a sequential programming order based on determining that the blocks 170 of the parity die (e.g., within the block stripe) are not corrupted. In some such examples, the memory system 110 may write the data and the parity data to the blocks 170 of the block stripe across the memory dies such that the parity data is stored at the blocks 170 of the parity die. However, in other examples, the memory system 110 may be configured to write the data and the parity data according to the reverse programming order based on determining that one or more blocks 170 of the parity die (e.g., within the block stripe) are corrupted. In some such examples, the memory system 110 may write the data and the parity data to the blocks 170 of the block stripe across the memory dies such that the data is stored at the non-corrupted blocks 170 of the parity die and the parity data is stored at the blocks 170 of an initial (e.g., or selected) memory die otherwise associated with storing data according to the sequential programming order. That is, if the parity die includes a single corrupted block 170, the data may be written to other blocks 170 associated with the parity die (e.g., within the block stripe) using the reverse programming order. Implementing the reverse programming order may therefore prevent the memory system 110 from retiring all the blocks 170 of the parity die based on determining a single block 170 is corrupted, which may improve efficiency and capacity for storing information within the memory system 110 (e.g., compared to previous implementations), among other advantages.

The system 100 may include any quantity of non-transitory computer readable media that support corrupt block detection for write ordering. For example, the host system 105 (e.g., a host system controller 106), the memory system 110 (e.g., a memory system controller 115), or a memory device 130 (e.g., a local controller 135), or any combination thereof may include or otherwise may access one or more non-transitory computer readable media storing instructions (e.g., firmware, logic, code) for performing the functions ascribed herein to the host system 105, the memory system 110, or the memory device 130, or combination thereof. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

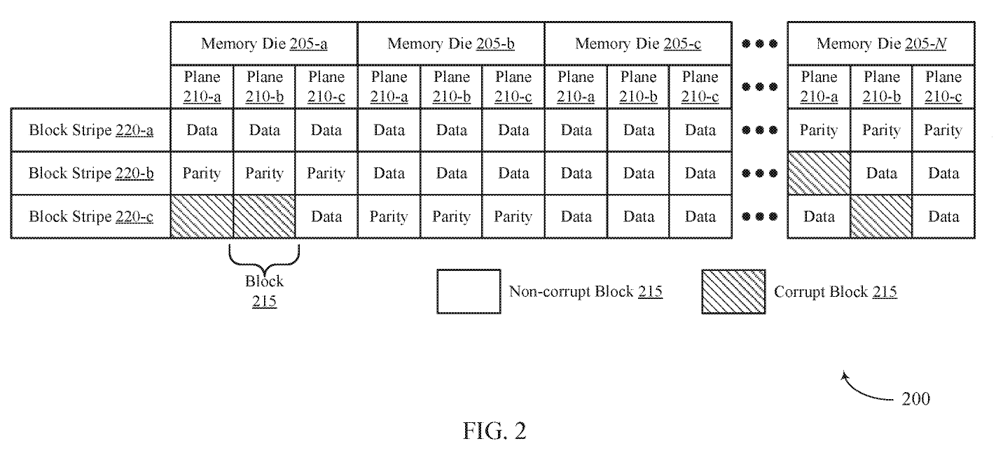

FIG. 2 shows an example of a block programming diagram 200 that supports corrupt block detection for write ordering in accordance with examples as disclosed herein. The block programming diagram 200 may illustrate aspects or operations of a system, which may be an example of a system 100, as described with reference to FIG. 1. For example, the block programming diagram 200 may illustrate operations performed by a memory system, which may be an example of a memory system 110. The block programming diagram 200 may illustrate examples of write operations performed by the memory system using a sequential programming order or a reverse programming order, where the reverse programming order may improve memory capacity based on identifying corrupt blocks of the memory system.

The block programming diagram 200 illustrates structures of a memory system for storing data or parity data. For example, the memory system may include a quantity of memory dies 205 (e.g., memory die 205-a, memory die 205-b, memory die 205-c, memory die 205-N), where each memory die 205 includes one or more arrays of memory cells. In some examples, each memory die 205 may be an example of a NAND memory die including one or more arrays of NAND memory cells configured to store data or parity data. In some implementations, each memory die 205 may be associated with a logical unit (LUN) of the memory system. The block programming diagram 200 illustrates the memory system including a memory die 205-a, a memory die 205-b, a memory die 205-c, and a memory die 205-N, where N is indicative of a quantity of total memory dies 205 associated with the memory system. For example, the memory system may include 64 memory dies, such that the memory die 205-a may be a first memory die of the memory system (e.g., associated with LUN0), the memory die 205-b may be a second memory die of the memory system (e.g., associated with LUN1), the memory die 205-c may be a third memory die of the memory system (e.g., associated with LUN2), and the memory die 205-N may be a 64th memory die of the memory system (e.g., associated with LUN63). Though the memory system is described as including 64 memory dies, it should be understood that the memory system could implement a different quantity of memory dies (e.g., where N is indicative of a different quantity that 64).

Each memory die 205 may include a quantity of planes 210 (e.g., plane 210-a, plane 210-b, plane 210-c), where each plane 210 may include blocks 215 of memory cells. For example, each plane 210 may be configured to include a quantity of blocks 215 of the respective memory die 205. In some cases, each plane 210 may be associated with a level of the memory die 205, such that each plane 210 includes a respective set of blocks 215 associated with the memory die 205. Each block 215 may include a quantity of pages, where each page is configured to be written with data or parity data corresponding to the data. That is, each page may be associated with one or more memory cells of the block 215. The block programming diagram 200 illustrates each memory die 205 including a plane 210-a, a plane 210-b, and a plane 210-c, however it should be understood that each memory die 205 could implement a different quantity of planes 210 (e.g., 4 planes 210, 8 planes 210, 16 planes 210).

The block programming diagram 200 also illustrates a quantity of block stripes 220 (e.g., block stripe 220-a, block stripe 220-b, block stripe 220-c). Each block stripe 220 may include a block 215 from each plane 210 of each memory die 205. That is, each block stripe 220 may include, from each memory die 205 (e.g., from the memory die 205-a, from the memory die 205-b, from the memory die 205-c, from the memory die 205-N), a block 215 from the plane 210-a, a block 215 from the plane 210-b, and a block 215 from the plane 210-c. In some cases, each block 215 of a block stripe 220 may have a same block index value within their respective plane 210. That is, a block 215 of the block stripe 220-a at the plane 210-a of the memory die 205-a may have a same block index value as a block 215 of the block stripe 220-a at the plane 210-a of the memory die 205-b or at the plane 210-b of the memory die 205-a. The block programming diagram 200 illustrates a block stripe 220-a, a block stripe 220-b, and a block stripe 220-c, however it should be understood that the memory system could implement a different quantity of block stripes 220. That is, the memory system may implement a quantity of block stripes 220 equal to the quantity of blocks in a plane 210 of a memory die 205.

The block programming diagram 200 illustrates write operations of the memory system, where each write operation may include writing data (e.g., host data, data bits) and corresponding parity data (e.g., XOR bits of the data bits, CRC bits, ECC bits) to the memory system. In some cases, each write operation may be performed on a block stripe basis, such that each write operation may include writing the data and the corresponding parity data to the blocks 215 of a block stripe 220 before performing a subsequent write operation to the blocks 215 of another block stripe 220. For example, the data and the corresponding parity data may be written to the block stripe 220-a during a first write operation, and additional data and additional corresponding parity data may be written to the block stripe 220-b during a later write operation.

Performing a write operation for a block stripe 220 may include writing the data and the parity data to the blocks of the block stripe 220 in an order across the block stripe 220. For example, the memory system may be configured to perform a write operation using a sequential programming order or a reverse programming order. The sequential programming order includes writing data and corresponding parity data to the blocks 215 of a block stripe 220 from the memory die 205-a (e.g., an initial memory die 205) to the memory die 205-N. For example, the data and the corresponding parity data may be written to the blocks 215 of the block stripe 220 in an order from the plane 210-a to the plane 210-c for each memory die 205 from the memory die 205-a to the memory die 205-N. In some such examples, the data may be written to the blocks 215 of the block stripe 220 at the planes 210 of the memory die 205-a, the memory die 205-b, the memory die 205-c, and each memory die except the memory die 205-N (e.g., up through memory die 205-N-1). That is, the memory die 205-N may be configured to function as a parity die, such that the memory die 205-N may be reserved for storing the parity data at the blocks 215 of the block stripe 220. The block programming diagram 200 illustrates the block stripe 220-a as an example of performing a write operation using the sequential programming order.

However, in some cases, one or more blocks of the memory die 205-N may be corrupted, which may affect which programming order is selected for performing a write operation. For example, the memory die 205-N may include a corrupt block, preventing the parity data from being stored at the memory die 205-N. In some examples, performing a write operation using the sequential programming order after determining that the memory die 205-N includes a corrupt block may include writing the data to the blocks 215 of the block stripe 220 from the memory die 205-a to a memory die (e.g., memory die 205-N-2, LUN 61) and writing the parity data to the blocks 215 of the block stripe 220 at a different memory die 205-N-1 otherwise configured to store the data. In some such examples, each block 215 of the memory die 205-N may be retired at the block stripe 220, which may decrease a capacity of the memory system by disabling the parity data from being stored at non-corrupted blocks of the memory die 205-N.

In some cases, rather than performing a write operation using the sequential programming order (e.g., when a block of the memory die 205-N is corrupt), the memory system may implement the reverse programming order. The reverse programming order includes writing data and corresponding parity data to the blocks 215 of a block stripe 220 from the memory die 205-N to the memory die 205-a. For example, the data and the corresponding parity data may be written to the blocks 215 of the block stripe 220 in an order from the plane 210-c to the plane 210-a for each memory die 205 from the memory die 205-N to the memory die 205-a. In some such examples, the data may be written to the blocks 215 of the block stripe 220 at the planes 210 of the memory die 205-N, the memory die 205-c, the memory die 205-b, and each memory die except the memory die 205-a. That is, the memory die 205-a may be reconfigured to function as the parity die, such that the memory die 205-a may be reserved for storing the parity data at the blocks 215 of the block stripe 220. However, the corrupt block 215 of the memory die 205-N may not be written with data or parity data based on the block 215 being corrupt. The block programming diagram 200 illustrates the block stripe 220-b as an example of performing a write operation using the reverse programming order.

In some cases, the memory system may perform a write operation using a modified reverse programming order, in which another memory die 205 is reconfigured to function as the parity die. For example, the memory system may determine that the memory die 205-N and the memory die 205-a each include one or more corrupt blocks 215. In some such examples, the memory system may reconfigure the memory die 205-b to function as the parity die, such that the memory die 205-b may be reserved for storing the parity data at the blocks 215 of the block stripe 220. Thus, the modified reverse programming order includes writing data and corresponding parity data to the blocks 215 of a block stripe 220 from the memory die 205-N to the memory die 205-a. For example, the data and the corresponding parity data may be written to the blocks 215 of the block stripe 220 in an order from the plane 210-c to the plane 210-a for each memory die 205 from the memory die 205-N to the memory die 205-a. In some such examples, the data may be written to the blocks 215 of the block stripe 220 at the planes 210 of the memory die 205-N, the memory die 205-c, the memory die 205-a, and each memory die except the memory die 205-b. However, in some implementations, when writing the data, the memory system may skip the memory die 205-b and may thus write from the memory die 205-c to the memory die 205-a. In some such implementations, the parity data may be written to the memory die 205-b after writing the data to the other memory dies 205-a. In other implementations, after writing the data to the memory die 205-c, the memory system may write the parity data to the memory die 205-b, then the memory system may continue writing the data to the memory die 205-a. However, the corrupt blocks 215 of the memory die 205-N and the memory die 205-a may not be written with data or parity data based on the blocks 215 being corrupt. The block programming diagram 200 illustrates the block stripe 220-c as an example of performing a write operation using the sequential programming order.

The memory system may determine whether to use the sequential programming order or the reverse programming order for each block stripe 220. For example, prior to performing a write operation for a block stripe 220, the memory system may determine whether to perform the write operation using the sequential programming order or the reverse programming order (e.g., or the modified reverse programming order). In some cases, the memory system may identify the memory die 205-N does not include a corrupt block, and the memory system may determine to use the sequential programming order. In other cases, the memory system may identify that the memory die 205-N includes a corrupt block 215, and the memory system may determine to use the reverse programming order. In some such cases, prior to performing the write operation using the reverse programming order, the memory system may determine which memory die 205 to reconfigure as the parity die. For example, the memory system may determine whether to use the reverse programming order or the modified programming order. In some implementations, the memory system may reconfigure another memory die (e.g., rather than the memory die 205-a or the memory die 205-b) to function as the parity die. In some such implementations, the memory system may determine which die to reconfigure as the parity die based on a plane mask identifying the quantity of corrupt blocks at each memory die within the block stripe 220.

Implementing the reverse programming order may improve the capacity of the memory system by continuing to store information within the memory die 205-N, rather than retiring the memory die 205-N. Additionally, implementing support for both the sequential programming order and the reverse programming order may enable the memory system to dynamically reconfigure the memory dies 205 of the memory system to efficiently store information associated with write operations, among other advantages.

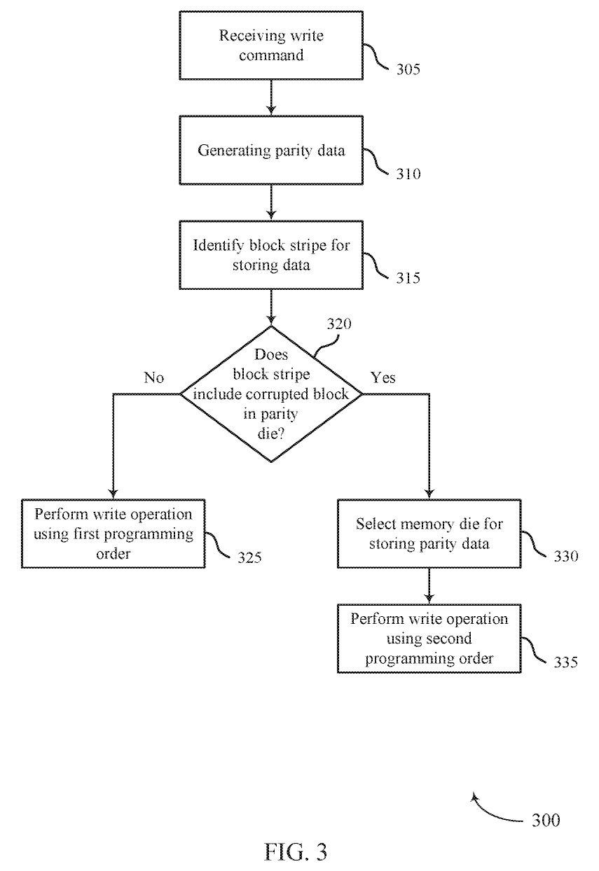

FIG. 3 shows an example of a process flow 300 that supports corrupt block detection for write ordering in accordance with examples as disclosed herein. The process flow 300 may illustrate aspects or operations of a system, which may be an example of a system 100, as described with reference to FIG. 1. For example, the process flow 300 may be implemented by a memory system, which may be an example of a memory system 110. That is, the process flow 300 may be implemented by a memory system controller 115 configured to cause the memory system to perform the steps described herein. Additionally, or alternatively, the process flow 300 may illustrates aspects or operations similar to a block programming diagram 200, as described with reference to FIG. 2. That is, the process flow 300 may depict operations associated with determining whether to use a sequential programming order or a reverse programming order for performing a write operation. In some cases, some steps of the process flow 300 may be performed in an alternative order, and/or some steps of the process flow 300 may be omitted from the process flow for illustrative clarity.

At 305, the memory system may receive a write command. For example, the memory system may receive a write command from a host system communicatively coupled with the memory system. The write command may include data, which may be an example of host data communicated from the host system. In some cases, the write command may include parity data associated with the data. In some examples, the write command may include an indication of a block stripe (e.g., which may be an example of a block stripe 220, as described with reference to FIG. 2) for storing the data.

At 310, the memory system may generate the parity data associated with the data of the write command. In some cases, the memory system may generate the parity data based on the write command not including the parity data in the write command. In other cases, the memory system may generate the parity data to perform an error control operation on the data. For example, the memory system may receive the data and the parity data from the host system as part of the write command, and the memory system may generate redundant parity data using the data included in the write command. In some such examples, the memory system may compare the parity data received as part of the write command to the redundant parity data, to determine whether an error occurred during transmitting the data from the host system to the memory system. That is, a mismatch between the received parity data and the generated parity data may indicate one or more errors occurred during transmission.

At 315, the memory system may identify a block stripe of the memory system for storing the data and the parity data. The memory system may identify the block stripe for performing the write operation based on access recency (e.g., determining a most recently accessed block stripe) and choosing a subsequent block stripe.

At 320, the memory system may determine whether the block stripe includes one or more corrupt blocks in a parity die of the memory system. For example, the memory system may initially configure a memory die (e.g., memory die 205-N) to function as the parity die. In some such examples, the memory system may determine whether the parity die includes at least one corrupt blocks in the block stripe. In some implementations, determining whether the parity die includes at least one corrupt blocks in the block stripe may include identifying a plane mask associated with the block stripe. The plane mask may include an indication of the corrupt blocks of the block stripe. If the plane mask includes an indication of at least one corrupt block at the parity die within the block stripe, the memory system may determine that the parity die includes at least one corrupt block. In some such implementations, the memory system may generate one or more plane masks and store the one or more plane masks to non-volatile memory of the memory system prior to performing the write operation associated with the write command. In some cases, the memory system may determine the parity die includes one or more corrupt blocks in the block stripe, and the process flow 300 may continue to step 330. In other cases, the memory system may determine the parity die does not include one or more corrupt blocks in the block stripe, and the process flow 300 may continue to step 325.

At 325, based on determining that the parity die does not include a corrupt block, the memory system may perform a write operation using a first programming order, which may be referred to as a default or corruption-free programming order. That is, the memory system may determine that the parity die does not include a corrupt block, and the memory system accordingly may select to use the first programming order for performing the write operation associated with the write command. Performing the write operation using the first programming order may include writing the data and the parity data to the blocks of the block stripe, across the block stripe from a first memory die (e.g., memory die 205-a) to the parity die (e.g., memory die 205-N). For example, the memory system may write the data to the blocks associated with each memory die except the parity die, and then the memory system may write the parity data to the parity die.

At 330, based on determining that the parity die does include a corrupt block, the memory system may select a memory die for storing the parity data. That is, the memory system may determine that the parity die includes one or more corrupt blocks, and the memory system accordingly may select another memory die for storing the parity data. The memory system may select a memory die to function as the parity die, and the memory system may reconfigure the memory die as the parity die. In some cases, the memory system may select the memory die based on a quantity of corrupt blocks in each memory die of the memory system. For example, the memory system may select a memory die with the lowest quantity of corrupt blocks in the block stripe. In some examples, the memory system may select the first memory die (e.g., memory die 205-a) to reconfigure as the parity die. However, in some examples, the memory system may select the second memory die to reconfigure as the parity die based on determining that the first memory die includes one or more corrupt blocks. In some cases, the memory system may use the one or more plane masks for selecting the memory die to reconfigure as the parity die.

At 335, the memory the memory system may perform a write operation using a second programming order, which is different than (e.g., the reverse of) the first programming order. That is, the memory system may determine that the parity die includes one or more corrupt blocks, and the memory system accordingly may select to use the second programming order for performing the write operation associated with the write command. Performing the write operation using the second programming order may include writing the data and the parity data to the blocks of the block stripe, across the block stripe from a last memory die (e.g., memory die 205-N) to the first memory die 205-a. Performing the write operation using the second programming order may further include writing parity data to the memory die selected at step 330 of the process flow. For example, the memory system may write the data to the blocks associated with each memory die except the memory die that is selected (e.g., reconfigured) as the parity die for that block stripe, and the memory system may write the parity data to that die. Thus, for example, performing the write operation using the first programming order may include writing the data and the parity data in accordance with a sequentially increasing order of die indices, and performing the write operation using the first programming order may include writing the data and the parity data in accordance with a sequentially decreasing order of die indices, or vice versa.

Implementing the process flow 300 at the memory system may support dynamically reconfiguring the memory system to perform the write operation using the sequential programming order or the reverse programming order. Enabling the memory system to determine whether to use the sequential programming order or the reverse programming order may improve storage efficiency of the memory system based on supporting dynamic reconfiguration of the memory system.

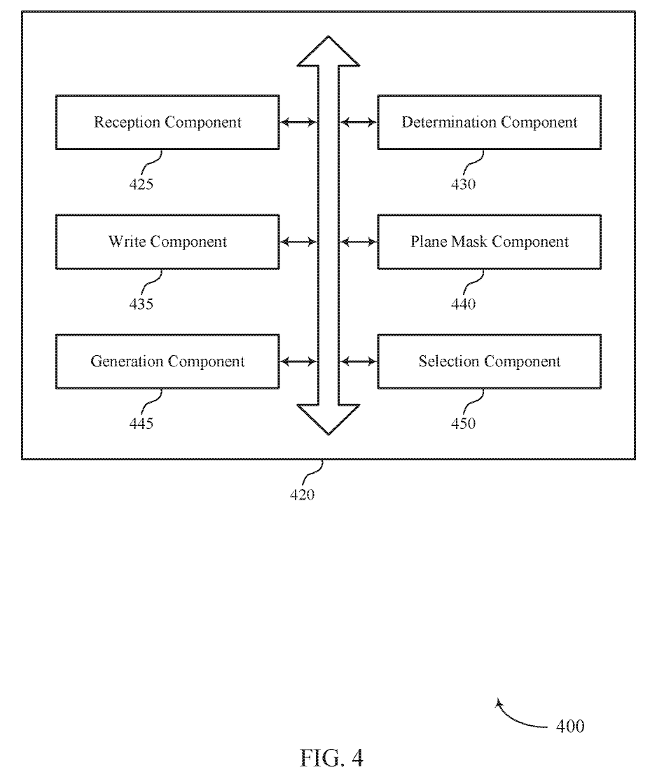

FIG. 4 shows a block diagram 400 of a memory system 420 that supports corrupt block detection for write ordering in accordance with examples as disclosed herein. The memory system 420 may be an example of aspects of a memory system as described with reference to FIG. 1 through FIG. 3. The memory system 420, or various components thereof, may be an example of means for performing various aspects of corrupt block detection for write ordering as described herein. For example, the memory system 420 may include a reception component 425, a determination component 430, a write component 435, a plane mask component 440, a generation component 445, a selection component 450, or any combination thereof. Each of these components, or components of subcomponents thereof (e.g., one or more processors, one or more memories), may communicate, directly or indirectly, with one another (e.g., via one or more buses).

The reception component 425 may be configured as or otherwise support a means for receiving a write command associated with a plurality of blocks spanning a plurality of memory dies of the memory system, where a memory die of the plurality of memory dies is associated with storing write parity data. The determination component 430 may be configured as or otherwise support a means for determining, based at least in part on receiving the write command, whether the memory die associated with storing write parity data includes at least one corrupted block within the plurality of blocks. The write component 435 may be configured as or otherwise support a means for writing data associated with the write command to the plurality of blocks in accordance with a block order that is based at least in part on whether the memory die includes at least one corrupted block within the plurality of blocks, the block order being a first order when the memory die includes at least one corrupted block within the plurality of blocks and being a second order when the memory die does not include at least one corrupted block within the plurality of blocks.

In some examples, to support writing the data associated with the write command, the write component 435 may be configured as or otherwise support a means for writing the data to the plurality of blocks in the first order based at least in part on determining that the memory die includes at least one corrupted block within the plurality of blocks. In some examples, the write component 435 may be configured as or otherwise support a means for writing parity data associated with the data to a second memory die of the plurality of memory dies based at least in part on writing the data in the first order, where the second memory die is associated with storing write data when the second order is used. In some examples, the determination component 430 may be configured as or otherwise support a means for determining whether the second memory die includes at least one corrupted block within the plurality of blocks. In some examples, the selection component 450 may be configured as or otherwise support a means for selecting, from among the plurality of memory dies, the second memory die for storing the parity data based at least in part on determining that the second memory die does not include at least one corrupted block within the plurality of blocks. In some examples, to support writing the data associated with the write command (e.g., in the first order), the write component 435 may be configured as or otherwise support a means for writing a portion of the data to the memory die associated with storing write parity data.

In some examples, to support writing the data associated with the write command, the write component 435 may be configured as or otherwise support a means for writing the data to the plurality of blocks in the second order based at least in part on determining that the memory die does not include at least one corrupted block within the plurality of blocks. In some examples, the write component 435 may be configured as or otherwise support a means for writing parity data associated with the data to the memory die based at least in part on writing the data in the second order.

In some examples, the first order is a reverse of the second order. In some examples, the first order is associated with writing data to the plurality of blocks from a highest-numbered memory die of the plurality of memory dies to a lowest-numbered memory die of the plurality of memory dies, and the second order is associated with writing data to the plurality of blocks from the lowest-numbered memory die to the highest-numbered memory die, or vice versa. In some examples, the memory die associated with storing write parity data is the highest-numbered memory die.

In some examples, the plane mask component 440 may be configured as or otherwise support a means for reading a plane mask from a non-volatile memory of the memory system based at least in part on receiving the write command, the plane mask including an indication of whether one or more corrupt blocks are present in the plurality of blocks, where determining whether the memory die includes at least one corrupted block within the plurality of blocks is based at least in part on reading the plane mask and identifying whether one or more corrupts blocks are present at the memory die in the plurality of blocks.

In some examples, the plane mask component 440 may be configured as or otherwise support a means for generating the plane mask based at least in part on determining whether one or more corrupted blocks are present in the plurality of blocks. In some examples, the plane mask component 440 may be configured as or otherwise support a means for storing the plane mask to the non-volatile memory, where reading the plane mask is based at least in part on storing the plane mask to the non-volatile memory.

In some examples, the plurality of blocks is a block stripe, the block stripe including a respective block from each plane of each memory die of the plurality of memory dies.

In some examples, the generation component 445 may be configured as or otherwise support a means for generating, by the memory system, parity data associated with data corresponding to the write command. In some examples, the selection component 450 may be configured as or otherwise support a means for selecting a storage location for the parity data, where whether the storage location is within the memory die or a second memory die is based at least in part on whether the memory die includes at least one corrupted block within the plurality of blocks. The write component 435 may be configured as or otherwise support a means for writing the parity data to the selected storage location.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

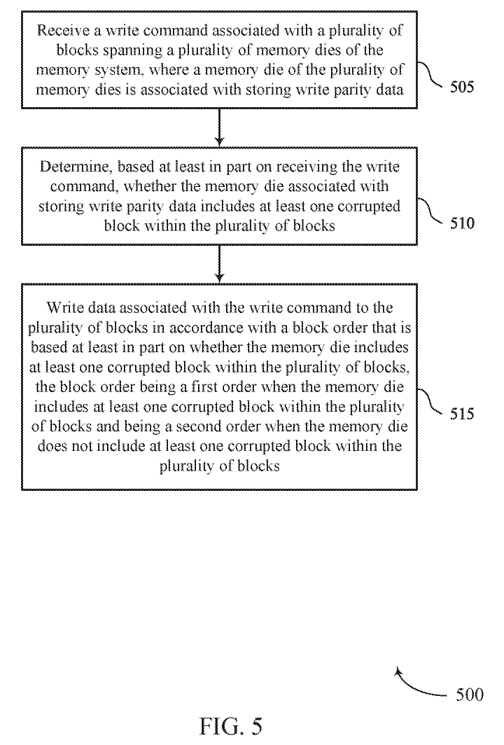

FIG. 5 shows a flowchart illustrating a method 500 that supports corrupt block detection for write ordering in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include receiving a write command associated with a plurality of blocks spanning a plurality of memory dies of the memory system, where a memory die of the plurality of memory dies is associated with storing write parity data. In some examples, aspects of the operations of 505 may be performed by a reception component 425 as described with reference to FIG. 4.

At 510, the method may include determining, based at least in part on receiving the write command, whether the memory die associated with storing write parity data includes at least one corrupted block within the plurality of blocks. In some examples, aspects of the operations of 510 may be performed by a determination component 430 as described with reference to FIG. 4.

At 515, the method may include writing data associated with the write command to the plurality of blocks in accordance with a block order that is based at least in part on whether the memory die includes at least one corrupted block within the plurality of blocks, the block order being a first order when the memory die includes at least one corrupted block within the plurality of blocks and being a second order when the memory die does not include at least one corrupted block within the plurality of blocks. In some examples, aspects of the operations of 515 may be performed by a write component 435 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving a write command associated with a plurality of blocks spanning a plurality of memory dies of the memory system, where a memory die of the plurality of memory dies is associated with storing write parity data; determining, based at least in part on receiving the write command, whether the memory die associated with storing write parity data includes at least one corrupted block within the plurality of blocks; and writing data associated with the write command to the plurality of blocks in accordance with a block order that is based at least in part on whether the memory die includes at least one corrupted block within the plurality of blocks, the block order being a first order when the memory die includes at least one corrupted block within the plurality of blocks and being a second order when the memory die does not include at least one corrupted block within the plurality of blocks.

Aspect 2: The method, apparatus, or non-transitory computer-readable medium of aspect 1, where writing the data associated with the write command includes operations, features, circuitry, logic, means, or instructions, or any combination thereof for writing the data to the plurality of blocks in the first order based at least in part on determining that the memory die includes at least one corrupted block within the plurality of blocks.

Aspect 3: The method, apparatus, or non-transitory computer-readable medium of aspect 2, further including operations, features, circuitry, logic, means, or instructions, or any combination thereof for writing parity data associated with the data to a second memory die of the plurality of memory dies based at least in part on writing the data in the first order, where the second memory die is associated with storing write data when the second order is used.

Aspect 4: The method, apparatus, or non-transitory computer-readable medium of aspect 3, further including operations, features, circuitry, logic, means, or instructions, or any combination thereof for determining whether the second memory die includes at least one corrupted block within the plurality of blocks and selecting, from among the plurality of memory dies, the second memory die for storing the parity data based at least in part on determining that the second memory die does not include at least one corrupted block within the plurality of blocks.

Aspect 5: The method, apparatus, or non-transitory computer-readable medium of any of aspects 2 through 4, where writing the data associated with the write command includes operations, features, circuitry, logic, means, or instructions, or any combination thereof for writing a portion of the data to the memory die associated with storing write parity data.

Aspect 6: The method, apparatus, or non-transitory computer-readable medium of any of aspects 1 through 5, where writing the data associated with the write command includes operations, features, circuitry, logic, means, or instructions, or any combination thereof for writing the data to the plurality of blocks in the second order based at least in part on determining that the memory die does not include at least one corrupted block within the plurality of blocks.

Aspect 7: The method, apparatus, or non-transitory computer-readable medium of aspect 6, further including operations, features, circuitry, logic, means, or instructions, or any combination thereof for writing parity data associated with the data to the memory die based at least in part on writing the data in the second order.

Aspect 8: The method, apparatus, or non-transitory computer-readable medium of any of aspects 1 through 7, where the first order is a reverse of the second order.

Aspect 9: The method, apparatus, or non-transitory computer-readable medium of aspect 8, where the first order is associated with writing data to the plurality of blocks from a highest-numbered memory die of the plurality of memory dies to a lowest-numbered memory die of the plurality of memory dies, and the second order is associated with writing data to the plurality of blocks from the lowest-numbered memory die to the highest-numbered memory die and the memory die associated with storing write parity data includes the highest-numbered memory die.

Aspect 10: The method, apparatus, or non-transitory computer-readable medium of any of aspects 1 through 9, further including operations, features, circuitry, logic, means, or instructions, or any combination thereof for reading a plane mask from a non-volatile memory of the memory system based at least in part on receiving the write command, the plane mask including an indication of whether one or more corrupt blocks are present in the plurality of blocks, where determining whether the memory die includes at least one corrupted block within the plurality of blocks is based at least in part on reading the plane mask and identifying whether one or more corrupts blocks are present at the memory die in the plurality of blocks.

Aspect 11: The method, apparatus, or non-transitory computer-readable medium of aspect 10, further including operations, features, circuitry, logic, means, or instructions, or any combination thereof for generating the plane mask based at least in part on determining whether one or more corrupted blocks are present in the plurality of blocks and storing the plane mask to the non-volatile memory, where reading the plane mask is based at least in part on storing the plane mask to the non-volatile memory.

Aspect 12: The method, apparatus, or non-transitory computer-readable medium of any of aspects 1 through 11, where the plurality of blocks includes a block stripe including a respective block from each plane of each memory die of the plurality of memory dies.

Aspect 13: The method, apparatus, or non-transitory computer-readable medium of any of aspects 1 through 12, further including operations, features, circuitry, logic, means, or instructions, or any combination thereof for generating, by the memory system, parity data associated with data corresponding to the write command and selecting a storage location for the parity data, where whether the storage location is within the memory die or a second memory die is based at least in part on whether the memory die includes at least one corrupted block within the plurality of blocks, and writing the parity data to the selected storage location.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The term “layer” or “level” used herein refers to a stratum or sheet of a geometrical structure (e.g., relative to a substrate). Each layer or level may have three dimensions (e.g., height, width, and depth) and may cover at least a portion of a surface. For example, a layer or level may be a three dimensional structure where two dimensions are greater than a third, e.g., a thin-film. Layers or levels may include different elements, components, and/or materials. In some examples, one layer or level may be composed of two or more sublayers or sublevels.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed, and a second condition or action may occur directly as a result of the previous condition or action occurring independent of whether other conditions or actions occur. In some examples, a first condition or action may be performed, and a second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively, (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor’s threshold voltage is applied to the transistor gate. The transistor may be “off” or “deactivated” if a voltage less than the transistor’s threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
receive a write command associated with a plurality of blocks spanning a plurality of memory dies of the memory system, wherein a memory die of the plurality of memory dies is associated with storing write parity data;
determine, based at least in part on receiving the write command, whether the memory die associated with storing the write parity data comprises at least one corrupted block within the plurality of blocks; and
write data associated with the write command to the plurality of blocks in accordance with a block order that is based at least in part on whether the memory die comprises at least one corrupted block within the plurality of blocks, the block order being a first order when the memory die comprises at least one corrupted block within the plurality of blocks and being a second order when the memory die does not comprise at least one corrupted block within the plurality of blocks.

2. The memory system of claim 1, wherein, to write the data associated with the write command, the processing circuitry is configured to cause the memory system to:
write the data to the plurality of blocks in the first order based at least in part on determining that the memory die comprises at least one corrupted block within the plurality of blocks.

3. The memory system of claim 2, wherein the processing circuitry is further configured to cause the memory system to:
write parity data associated with the data to a second memory die of the plurality of memory dies based at least in part on writing the data in the first order, wherein the second memory die is associated with storing write data when the second order is used.

4. The memory system of claim 3, wherein the processing circuitry is further configured to cause the memory system to:
determine whether the second memory die comprises at least one corrupted block within the plurality of blocks; and
select, from among the plurality of memory dies, the second memory die for storing the parity data based at least in part on determining that the second memory die does not comprise at least one corrupted block within the plurality of blocks.

5. The memory system of claim 2, wherein, to write the data associated with the write command, the processing circuitry is configured to cause the memory system to:
write a portion of the data to the memory die associated with storing the write parity data.

6. The memory system of claim 1, wherein, to write the data associated with the write command, the processing circuitry is configured to cause the memory system to:
write the data to the plurality of blocks in the second order based at least in part on determining that the memory die does not comprise at least one corrupted block within the plurality of blocks.

7. The memory system of claim 6, wherein the processing circuitry is further configured to cause the memory system to:
write parity data associated with the data to the memory die based at least in part on writing the data in the second order.

8. The memory system of claim 1, wherein the first order is a reverse of the second order.

9. The memory system of claim 8, wherein:
the first order is associated with writing data to the plurality of blocks from a highest-numbered memory die of the plurality of memory dies to a lowest-numbered memory die of the plurality of memory dies, and the second order is associated with writing data to the plurality of blocks from the lowest-numbered memory die to the highest-numbered memory die, and
the memory die associated with storing the write parity data comprises the highest-numbered memory die.

10. The memory system of claim 1, wherein the processing circuitry is further configured to cause the memory system to:
read a plane mask from a non-volatile memory of the memory system based at least in part on receiving the write command, the plane mask comprising an indication of whether one or more corrupt blocks are present in the plurality of blocks, wherein determining whether the memory die comprises at least one corrupted block within the plurality of blocks is based at least in part on reading the plane mask and identifying whether one or more corrupts blocks are present at the memory die in the plurality of blocks.

11. The memory system of claim 10, wherein the processing circuitry is further configured to cause the memory system to:
generate the plane mask based at least in part on determining whether one or more corrupted blocks are present in the plurality of blocks; and
store the plane mask to the non-volatile memory, wherein reading the plane mask is based at least in part on storing the plane mask to the non-volatile memory.

12. The memory system of claim 1, wherein the plurality of blocks comprises a block stripe comprising a respective block from each plane of each memory die of the plurality of memory dies.

13. The memory system of claim 1, wherein the processing circuitry is further configured to cause the memory system to:
generate, by the memory system, parity data associated with data corresponding to the write command;
select a storage location for the parity data, wherein whether the storage location is within the memory die or a second memory die is based at least in part on whether the memory die comprises at least one corrupted block within the plurality of blocks; and
write the parity data to the selected storage location.

14. A non-transitory computer-readable medium storing code, the code comprising instructions executable by one or more processors to:
receive a write command associated with a plurality of blocks spanning a plurality of memory dies of a memory system, wherein a memory die of the plurality of memory dies is associated with storing write parity data;
determine, based at least in part on receiving the write command, whether the memory die associated with storing the write parity data comprises at least one corrupted block within the plurality of blocks; and
write data associated with the write command to the plurality of blocks in accordance with a block order that is based at least in part on whether the memory die comprises at least one corrupted block within the plurality of blocks, the block order being a first order when the memory die comprises at least one corrupted block within the plurality of blocks and being a second order when the memory die does not comprise at least one corrupted block within the plurality of blocks.

15. The non-transitory computer-readable medium of claim 14, wherein, to write the data associated with the write command, the instructions are executable by the one or more processors to:
write the data to the plurality of blocks in the first order based at least in part on determining that the memory die comprises at least one corrupted block within the plurality of blocks.

16. The non-transitory computer-readable medium of claim 15, wherein the instructions are further executable by the one or more processors to:
write parity data associated with the data to a second memory die of the plurality of memory dies based at least in part on writing the data in the first order, wherein the second memory die is associated with storing write data when the second order is used.

17. The non-transitory computer-readable medium of claim 16, wherein the instructions are further executable by the one or more processors to:
determine whether the second memory die comprises at least one corrupted block within the plurality of blocks; and
select, from among the plurality of memory dies, the second memory die for storing the parity data based at least in part on determining that the second memory die does not comprise at least one corrupted block within the plurality of blocks.

18. The non-transitory computer-readable medium of claim 15, wherein, to write the data associated with the write command, the instructions are executable by the one or more processors to:
write a portion of the data to the memory die associated with storing the write parity data.

19. The non-transitory computer-readable medium of claim 14, wherein, to write the data associated with the write command, the instructions are executable by the one or more processors to:
write the data to the plurality of blocks in the second order based at least in part on determining that the memory die does not comprise at least one corrupted block within the plurality of blocks.

20. The non-transitory computer-readable medium of claim 19, wherein the instructions are further executable by the one or more processors to:
write parity data associated with the data to the memory die based at least in part on writing the data in the second order.

21. A method by a memory system, comprising:
receiving a write command associated with a plurality of blocks spanning a plurality of memory dies of the memory system, wherein a memory die of the plurality of memory dies is associated with storing write parity data;
determining, based at least in part on receiving the write command, whether the memory die associated with storing the write parity data comprises at least one corrupted block within the plurality of blocks; and
writing data associated with the write command to the plurality of blocks in accordance with a block order that is based at least in part on whether the memory die comprises at least one corrupted block within the plurality of blocks, the block order being a first order when the memory die comprises at least one corrupted block within the plurality of blocks and being a second order when the memory die does not comprise at least one corrupted block within the plurality of blocks.
